(19) United States
(12) Patent Application Publication
(10) Pub. No.: US 2015/0179053 A1
(43) Pub. Date: Jun. 25, 2015

(54) SYSTEM AND METHOD TO DETECT A PRESENCE OF AN OBJECT RELATIVE TO A SUPPORT

(71) Applicant: General Electric Company, Schenectady, NY (US)

(72) Inventors: Brandon Good, Schenectady, NY (US); Charles Theurer, Alplaus, NY (US)

(73) Assignee: General Electric Company, Schenectady, NY (US)

(21) Appl. No.: 14/135,777

(22) Filed: Dec. 20, 2013

(51) Int. Cl. G08B 26/00; G06K 19/077; G06K 7/10; G06K 19/07

(52) U.S. Cl. CPC G08B 26/007; G06K 19/0722; G06K 19/0726; G06K 19/07788; G06K 7/10435

(57) ABSTRACT

A system and method to detect a presence of an object relative to a support is provided. The system can generally include an antenna circuit embedded in the support; and a tuner controller electrically connected to the antenna circuit. The tuner controller can be operable to measure a change in an impedance of the antenna circuit associated with a change in presence of the object to and from the support, and based on this comparison, can generate an output signal indicative of the change in presence of the object on the support.

### TECHNICAL FIELD

The subject herein generally relates to a system and method to detect a presence associated with an object relative to a support, and more specifically, to detect a presence associated with a person on a bed.

### BACKGROUND

Generally symptomatic of the complex systems, many production and service industries face a need to improve efficiency by reducing wait times. In one example, hospitals and healthcare facilities generally face a need to improve the problem of wait times of patients, doctors, and nurses. In particular, patients generally face wait times to be admitted to a bed, as well as to be discharged from a bed. Other industries face similar problems with inefficiencies in their production or service offerings.

In regard to bed management at a hospital or clinic, one source of the problem of wait times is not knowing if a bed is occupied or not. Currently, many hospitals try to manually manage bed occupancy through one by one manual entry of patients to and from beds, which contributes to the generally inefficient start and stop flow of healthcare delivery to the patients. Known attempts to automate bed management include reliance on radio frequency identification (RFID) technology to detect when a patient with a tag is within the proximity of a reader or not. However, RFID technology alone is generally unable to confirm if the patient is actually on a bed. So more recent attempts to address this problem have included augmenting RFID technology with use of pressure sensors on the bed. However, this additional sensor integration can be generally complex and cumbersome to deploy.

Therefore, there is a need for alternative technologies to detect presence of objects relative to a support that is effective and yet simple to deploy. This above-mentioned need can be addressed by the subject matter described herein in the following description.

### BRIEF SUMMARY

The system and method of the subject matter described herein is directed to provide a system or method operable to detect a presence associated with an object relative to a support that is efficient and easy to deploy.

According to one embodiment, a system to detect a presence of an object relative to a support is provided. The embodiment of the system includes an antenna circuit embedded in the support; and a controller electrically connected to the antenna circuit, wherein the controller is operable to measure a change in an impedance of the antenna circuit in response to a test signal through the antenna circuit for comparison to a threshold associated with a change in presence of the object on the support, and based on comparison, is operable to generate an output signal indicative of the change in presence of the object on the support.

According to another embodiment, a method to detect a presence of an object relative to a support is provided. The method can include the steps of providing a test signal to an antenna circuit provided at the support; measuring a change in an impedance of the antenna circuit in response to the test signal for comparison to a threshold associated with a change in presence of the object on the support, and based on comparison; and creating an output indicative of the change in presence of the object on the support.

Various other features, objects, and advantages of the subject matter will be made apparent to those skilled in the art from the accompanying drawings and detailed description thereof.

### BRIEF DESCRIPTION OF THE DRAWINGS

FIG. 1 is a schematic diagram of an embodiment of a system in accordance with the subject matter described herein.

FIG. 2 is a schematic flow diagram of an embodiment of a method of operating the system of FIG. 1 in accordance with subject matter described herein.

### DETAILED DESCRIPTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

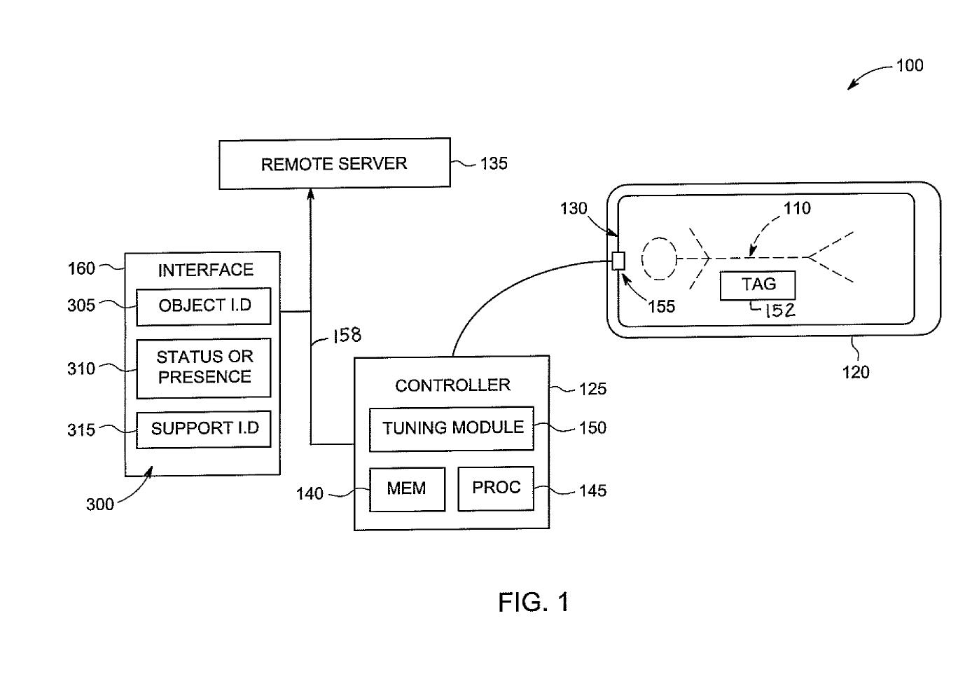

FIG. 1 illustrates a schematic diagram of one embodiment of a system 100 to detect a presence of an object 110 relative to a support 120. The following description is of one example of utilization of the system 100 directed to bed management at a healthcare facility (e.g., clinic, hospital), where the object 110 can be a person and the support 120 can be a bed or mattress or the like, as shown in FIG. 1. However, the utilization or application of the system 100 can vary.

The system 100 can generally include a tuner controller 125 in communication with an antenna circuit 130 at the support 120, and a remote server, computer or workstation or the like (herein “remote server 135”). The tuner controller 125 can include a memory 140 having programming instructions representative of steps for execution by a processor 145 in detecting the presence of the object 110 relative to the support 120. The memory 140 can be generally configured to store the program instructions for execution by the processor 145 to perform the steps in operation of the system 100, although some or all of the programmed instructions can be stored and/or executed elsewhere. A variety of different types of memory 140, such as a random access memory (RAM) or a read only memory (ROM) in the system 100 or a floppy disk, hard disk, CD ROM, DVD ROM, or other computer readable medium which is read from and/or written to by a magnetic, optical, or other reading and/or writing device that is coupled to the processor 145, can be used. The tuner controller 125 can be located integrally as part of a common back-office workstation with the remote server 135 or independent/remote thereof and not be limiting on the subject matter described herein. An example of the processor 145 can be a central processing unit (CPU), but the type of processor 145 can vary.

The tuner controller 125 can programmed to automatically detect a threshold deviation in impedance of the antenna circuit 130 from a norm or baseline impedance in response to test signal and the presence of the object 110. The measure of the change in impedance can be based on a measure of a first impedance of the antenna circuit 130 without the object 110 present and a second impedance of the antenna with the object 110 present. According to one embodiment, the tuner controller 125 can be programmed or operable to measure change in the impedance or attenuation based on measure of a first resonant frequency of the test signal that passes through the antenna circuit 130 without the object 110 present, for comparison with the measure of a second resonant frequency of the test signal that passes through the antenna circuit 130 with the object 110 present.

In response to detecting the deviation in impedance of the antenna circuit 130, the tuner controller 125 can be programmed or operable to automatically adjust or change (e.g., add or subtract) impedance such that the measured impedance of the antenna circuit 130 in response to the test signal returns to within a threshold of the baseline impedance or range. To automatically change the impedance as described above so as to attain or return to a desired resonant frequency of the test signal that passes through the antenna circuit 130, the tuner controller 125 can include a tuning module 150 operable to automatically add or subtract resistance, capacitance, inductance or combination thereof in series or parallel to the antenna circuit 130.

The tuner controller 125 can also be operable to generate an output signal indicative of a detected or measured threshold change or deviation in the impedance of the antenna circuit 130 to the test signal with the presence of the object 110. In the example shown in FIG. 1, the tuner controller 125 can be operable to communicate the output signal to the remote server 135 in response to detecting the change in impedance caused by the presence of a person resting on the bed support 120. The measure or detection of the change in impedance of the antenna circuit 130 can be based on a change in pass through parameters of the test signal through the antenna circuit 130, or based on the need to add or subtract impedance from the antenna circuit 130 to maintain the pass-through parameters (e.g., resonant frequency) of the test signal. In a like manner, the tuner controller 125 can be operable to communicate the output signal to the remote server 135 in response to detecting or measuring the change in impedance of the antenna circuit 130 with the loss in presence (e.g., leaving the bed support 120) of the person.

The output signal can generally include information or data indicative of an identification of the tuner controller 125 or the antenna circuit 130. In another example, the tuner controller 125 can be a tag reader of a type (e.g., RFID, LF, HF, Bluetooth, bar code, etc.) operable to detect an identification of a tag 152 associated with the object 110, and thereby transmit the identification of the tag 152 or object 110 associated therewith in the output signal to the remote server 135.

An embodiment of the antenna circuit 130 can be of various composition of electrical conductivity (e.g., copper wire, silver wire, etc.) operable to transmit the test signal received from the tuner controller 125. The shape of the antenna circuit 130 (e.g., circular, oval, rectangular, etc.) can vary. The antenna circuit 130 can be mounted at, attached to, or embedded within the structure of the support 120. According to the example shown in FIG. 1, the antenna circuit 130 extends near a general circumference of and embedded within the support 120, but is located to be a predefined space apart from an object 110 in the presence of the support 120. Yet, the antenna circuit 130 can be located around the circumference of the support 120, or beneath the support 120 and is not limiting of the subject matter described herein.

One embodiment of the antenna circuit 130 can be pre-tuned or configured to a predefined impedance (e.g. range or value of attenuation of a test signal measured as a resonant frequency) based on composition, structural dimensions, shape, etc. Another embodiment of the antenna circuit 130 can include a tuning circuit 155 operable to controllably adjust the impedance of the antenna circuit 130 within a predefined impedance when the object 110 is not on the support 120. An example of the resonant frequency can be 125 kHz or predefined threshold range (e.g., within frequency range of 120 kHz to 140 kHz) thereof. One example of the tuning circuit can include slots to removeably install electric circuit components (e.g., capacitors, resistors, inductors, etc.) to add or subtract impedance in series or parallel so as to tune the antenna circuit 130 to a desired or predefined impedance (e.g., based on resonant frequency of test signal passing through).

The remote server 135 can be generally configured to communicate with the tuner controller 125 over a network 158 (e.g., Internet, intranet, LAN, WAN, cloud, etc.). According to one example, the remote server 135 can be programmed to calculate a correlation of the tuner controller 125 to an identification of a room or defined space where the tuner controller 125 is located. In another example, the output signal can include an identification of the tag associated with the object 110 and detected by the tuner controller 125.

The tuner controller 125 or the remote server 135 can further include connection (wired or wireless) in communication with an interface 160. The interface 160 can include mechanisms receive input or to illustrate output to an operator of the system 100. The interface 160 can be located at either the tuner controller 125 or the remote server 135 or at both or remote relative to both the tuner controller 125 and remote server 135. Examples of the interface 160 can include a keyboard, touchscreen, a monitor, mouse, microphones, etc. know in the art to receive input from the operator. The interface 160 can also include a graphic illustration monitor, LEDs, speakers, etc. known in the art to provide output to the operator.

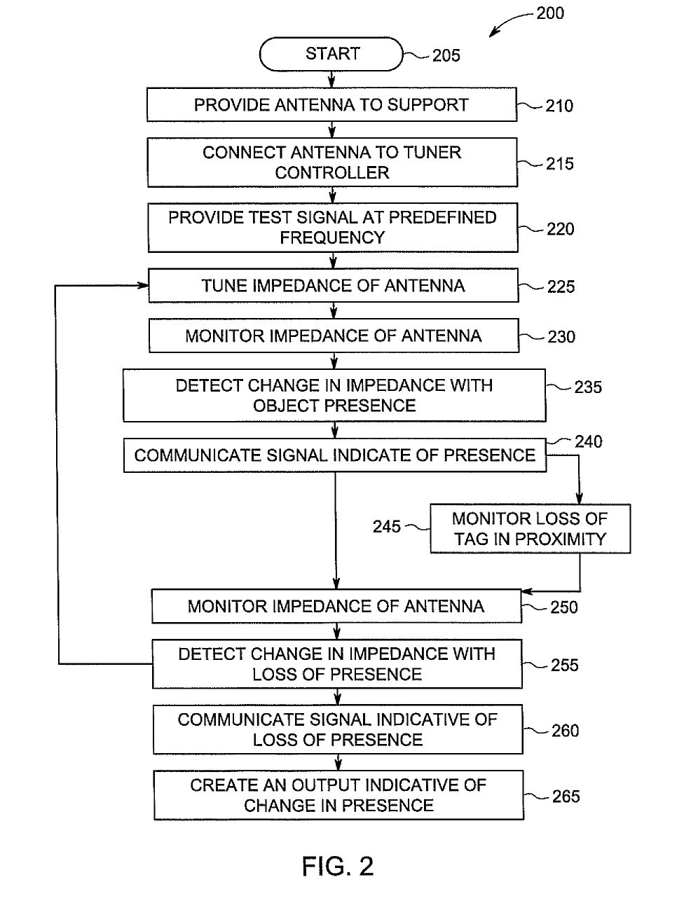

Having provided an embodiment of one construction of the system 100 in accordance with above-description, the following is a description of an embodiment of a method 200 (See FIG. 2) to operate the system 100 in accordance with the subject matter described herein to detect a presence of an object 110 relative to a support 120. It should also be understood that the sequence of the acts or steps of the method 200 as discussed in the foregoing description can vary. Also, it should be understood that the method 200 may not require each act or step in the foregoing description, or may include additional acts or steps not disclosed herein. It should also be understood that one or more of the steps of the method 200 can be represented by one or more computer program modules of computer-readable program instructions stored in the memory 140 for execution by the processor 145.

Step 205 can include the start of the method 200. Step 210 includes providing the antenna circuit 130 to the support 120. In one embodiment, the antenna circuit 130 is embedded within a structure of the support 120 (e.g., bed mattress) and in a configuration within a predefined distance of the outer circumference of the support 120. Step 215 includes connecting the antenna circuit 130 to the tuner controller 125 (e.g., tag reader) in the near vicinity (e.g., same room or defined space) of the support 120 and the antenna circuit 130.

Step 220 can include the tag reader providing a signal (e.g., alternating current) at a predefined frequency to the antenna circuit 130 with no object 110 present on the support 120. Step 225 can include tuning an impedance of the antenna circuit 130. An embodiment of tuning an impedance of the antenna circuit 130 can include changing an impedance of the antenna circuit 130 until detecting a predefined pass through or filter of the signal (e.g., resonant frequency). In one embodiment, the tuner controller 125 can include a capacitance adjuster operable to automatically change the impedance (e.g., capacitance in series or parallel with) of the antenna circuit 130. An embodiment of the antenna circuit 130 can also be a tuned antenna circuit 130 having a tuning circuit in series or parallel with the antenna circuit 130. An embodiment of the tuning circuit can be configured to have at least one slot to receive one or more capacitors in series or parallel with the antenna circuit 130 so as to adjust an impedance of the antenna circuit 130 in response to the signal from the tag reader. This can be an iterative process until the antenna circuit 130 is tuned at to the predefined frequency (e.g., resonant frequency) when the object 110 is not present on the bed.

Step 230 can include monitoring change in impedance such as via the tuner controller 125 providing test signal to the antenna circuit 130 and measuring for a predefined change in impedance of the antenna circuit 130 to test if a change in presence. Step 230 can include the tuner control (e.g., tag reader) sending the test signal and measuring for the change in impedance in response to detecting a tag associated with the object 110 within a proximity of the tuner control. In the example where the object 110 is person having an anatomical structure comprising a threshold composition of water that triggers the change impedance of the antenna circuit 130. However, application of the system 100 is limited to detecting presence of object 110 that is a person. The system 100 can be utilized in detecting the presence of various types of objects 110, dependent on an ability of the object 110 or its structural composition (e.g., water) to cause a threshold change in an impedance of the antenna circuit 130 receiving the object 110.

Further, although this description is directed where being “present” or the “presence” is of a person on a bed, detection of the “presence” of the object 110 can vary from this example. For instance, detection of “presence” can be directed to the object 110 passing through a support 120 (e.g., the doorframe or window) or at a location or threshold proximity of the support 120 and is not limiting on the subject matter described herein.

Step 235 can include detecting change in impedance with change in presence of the object 110 relative to the support 120. Step 235 can include the tuner controller 125 automatically adjusting the impedance of the antenna circuit 130 in response to detecting predefined deviation or change in impedance associated with the presence of the object 110 on the support 120 so as to re-tune the antenna circuit 130 to the predefined frequency (e.g., resonant frequency). In response to automatically adjusting or changing the impedance, step 240 can include the tag reader communicating a signal indicative a change in present of the object 110 on the support 120. In this first example, the change in presence of the object 110 is associated with the object 110 first coming to rest on the support 120. The presence signal can be communicated to a remote server 135.

Step 245 can include detecting the tag no longer within a proximity of the tuner controller 125. For example, the tuner controller 125 can no longer detect a response associated with a periodic signal either sent to the tag or returned from the tag indicative of the tag (and associated object 110) leaving the proximity of the tuner controller 125.

Step 250 can include providing the test signal to the antenna circuit 130 and detecting the change in impedance of the antenna circuit 130. Step 250 can be executed in response to detecting the tag no longer within a proximity of the tuner controller 125, or in response to a periodic or generally continuous test signal provided by the tuner controller 125 to the antenna circuit 130.

Step 255 can include detecting the change in impedance associated with the antenna circuit 130. In this example, the change in impedance would be associated with the object 110 leaving the presence on the support 120. Similar to the steps described above, the measure of the change in impedance can be associated with the tuner controller 125 adjusting the impedance of the antenna circuit 130 until detecting the resonant frequency associated with the pass through of the test signal provided to the antenna circuit 130. Step 250 can be iterated until the tuner controller 125 detects return of the predefined resonant or baseline reference impedance (e.g., resonant frequency associated therewith) of the antenna circuit 130 with no presence of the object 110 relative to the support 120, as described in step 225.

Step 260 can include communicating a presence signal (or a non-presence signal different in frequency or amplitude or polarity) to the remote computer controller indicative of the loss of presence of the object 110 on the support 120. Step 265 can include creating an output 300 illustrative of the change in presence of the object 110 relative to the support 120 for viewing by the user of the system 100. Referring back to FIG. 1, an example of the interface 160 can include a graphic illustration 305 of an identifier of the object 110, a graphic illustration 310 indicative of the change in presence or current status of the presence of the object 110 relative to the support 120, and a graphic illustration 315 identifier of the support 120 (e.g., room identifier where support 120 located, identifier of the support 120 itself, etc.). Yet, the graphic illustration can be LEDs, audio signals, or the like and is not limiting on the subject matter described herein.

The system 100 described above is not limited to this one example of utilization in a healthcare facility, and can be utilized in various industrial settings or with respect to various objects 110 and is not limiting on the subject matter described herein. The support 120 utilizing the system 100 can vary, such as mobile supports (e.g., gurney, wheelchair, etc.), other types of static structural supports (e.g., chairs, etc.), and types of structural openings (door frame, window, etc.) and is not limiting on the subject matter described herein. Furthermore, the system 100 can be utilized in other environments, such as security in detecting unauthorized or authorized presence at locations or through entryways, or miscellaneous industrial settings where the system 100 can be utilized to detect presence of objects 110 that are inanimate or other living organisms (e.g., animals, plants, etc.) at locations or in proximity of supports.

A technical advantage of the subject matter described above is to provide a system 100 and method 200 to detect the presence of an object 110 at a location or support 120. In particular this method can be used to detect that a person is located on or in proximity of a bed. The tuner controller 125 can be part of an tag identification system (e.g., RFID, Bluetooth, LF, UHF, etc.). The antenna circuit 130 can be tuned for a particular resonant frequency and located on or in the frame/mattress of a bed. When a person is located on the bed, the impedance of the antenna circuit 130 will change (or detune) slightly. This change in impedance can be detected by the tuner controller 125 and used to determine that a person is present in the bed. When the person leaves the bed, tuner controller 125 will need to return the impedance of the antenna circuit 130 (or retune) to return to exhibit the approximately same resonant frequency as when before the person was present on the bed, and generate an output signal indicative that there is nobody in the bed. This method could be applied to any number of locations (chair, doorway, car, etc.). The antenna circuit 130s can be tuned to a desired frequency (e.g., resonant frequency) by specifying the structural parameters of a wire loop, the number of turns of wire loops, and the addition or subtraction of capacitors in series or parallel with the wire loops. The tuner controller 125 can be operable to provide fine tuning (addition or subtraction of capacitance, resistance or inductance) to a more price value of impedance (e.g., based on resonant frequency). By measuring this change in the impedance of the antenna circuit 130 when the object 110 such as a person is present on the support 120 such as a bed without a need for unnecessary integration of additional sensors (e.g., pressure sensors on support 120). The integration of a tag reader as the tuner controller 125 allows the system 100 to selectively detect when a tag associated with the object 110 is in a proximity of the support 120 so as to selectively trigger transmission of the test signal from the tuner controller 125 to the antenna circuit 130, saving cost and energy.

This written description uses examples to disclose the subject matter, and to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system to detect a presence of an object on a support, the system comprising:
an antenna circuit embedded in the support; and
a tuner controller electrically connected to the antenna circuit, wherein the tuner controller is operable to measure a change in an impedance of the antenna circuit 130 in response to a test signal through the antenna circuit for comparison to a threshold associated with a change in presence of the object on the support, and based on comparison, is operable to generate an output signal indicative of the change in presence of the object on the support.

2. The system of claim 1, wherein the object is a person and the support is a bed.

3. The system of claim 1, wherein the tuner controller is a tag reader, and further including a first tag located at the object, wherein in response to detecting the first tag within a threshold proximity of the tag reader, the tag reader generates the test signal to the antenna circuit.

4. The system of claim 1, wherein the antenna circuit further includes a tuning circuit operable to controllably adjust the impedance of the antenna circuit within a predefined range when the object is not on the support.

5. The system of claim 1, wherein the test signal applied to the antenna circuit is within a frequency range of 120 kHz to 140 kHz.

6. The system of claim 1, wherein the tuner controller measures the change in the impedance of the based on a change in a unique frequency of threshold attenuation of the electrical signal through the in response to the object on the support.

7. The system of claim 1, where the measure of the change in the impedance of the antenna circuit in response to the test signal includes a measure of a change in the impedance of the antenna circuit to an alternating current signal applied to the antenna circuit that is associated with one of a change in a resistance of the antenna circuit and a change in capacitance of the antenna circuit associated with the change in presence of the object relative to the support.

8. The system of claim 1, wherein the tuner controller measures a first impedance of the antenna circuit without the object on the support, and a second impedance of the antenna circuit with the object on the support, and the difference between the first and second impedance for comparison to a threshold.

9. The system of claim 1, wherein the antenna circuit is embedded within the support.

10. The system of claim 1, wherein the antenna circuit is located a threshold distance from the object when the object is on the support.

11. A method to detect a presence of an object on a support, the system comprising:
providing a test signal to an antenna circuit provided at the support;
measuring a change in an impedance of the antenna circuit in response to the test signal\for comparison to a threshold associated with a change in presence of the object on the support, and based on comparison; and
creating an output indicative of the change in presence of the object on the support.

12. The method of claim 11, wherein the object is a person and the support is a bed.

13. The method of claim 11, further including the steps of:
detecting a first tag associated with a second object within a threshold proximity of a tag reader;
communicating a first tag signal to a remote server indicative of detecting the first tag; and
detecting an association of the first and second objects based on a comparison a time associated with each of the first tag signal and the output signal indicative of the change in presence.

14. The method of claim 11, further including the step of:
adjusting an impedance of the antenna circuit with a tuning circuit to within a predefined range when the object is not present on the support.

15. The system of claim 1, wherein the step of providing the test signal to the includes communicating an alternating current signal with a frequency range of 120 kHz to 140 kHz.

16. The system of claim 1, wherein the step of measuring the impedance of the antenna circuit includes measuring a change in a unique frequency of threshold attenuation of the test signal through the in response to the object on the support.

17. The system of claim 1, where the step of measuring the change in the impedance of the antenna circuit in response to the test signal includes measuring a change in the impedance of the antenna circuit to an alternating current signal applied to the antenna circuit that is associated with one of a change in a resistance of the antenna circuit or a change in capacitance of the antenna circuit associated with the change in presence of the object on the support.

18. The system of claim 1, wherein the step of measuring the change in the impedance of the antenna circuit includes measuring a first impedance of the antenna circuit without the object on the support and a second impedance of the antenna circuit with the object on the support, and calculating the difference between the first and second impedance for comparison to a threshold.

19. The system of claim 1, further including the step of:
embedding the antenna circuit within a construction of the support.

20. The system of claim 1, further including the step of locating the antenna circuit on the support such that the antenna circuit is a threshold distance from the object when the object is present on the support.
